(19) United States
(12) Patent Application Publication
(10) Pub. No.: US 2026/0312916 A1
(43) Pub. Date: Oct. 8, 2026

(54) SYSTEMS AND METHODS FOR ACCURATE LINK LOOP LATENCY MEASUREMENT AND DYNAMIC BACKLOG REDUCTION OF RECEIVER BUFFER

(71) Applicants: Advanced Micro Devices, Inc., Santa Clara, CA (US); ATI Technologies ULC, Markham (CA)

(72) Inventors: Mingyu Liu, Austin, TX (US); Michael Tresidder, Willow City, TX (US); David Alan Brown, Ontario (CA); Shaofeng An, Ontario (CA); YanFeng Wang, Ontario (CA)

(73) Assignees: Advanced Micro Devices, Inc., Santa Clara, CA (US); ATI Technologies ULC, Markham (CA)

(21) Appl. No.: 19/640,862

(22) Filed: Apr. 7, 2026

Related U.S. Application Data
(60) Provisional application No. 63/784,317, filed on Apr. 7, 2025.

(51) Int. Cl. H04L 47/43; H04L 43/0864

(52) U.S. Cl. CPC H04L 47/43; H04L 43/0864

(57) ABSTRACT

Systems and methods for reducing, by a link partner, backlog at a receiver buffer of the other link partner. Each link partner includes at least one circuit coupled between a data fabric and an interconnect link of an interconnect fabric. The at least one circuit includes a receiver configured to receive datagrams from the interconnect fabric and a transmitter configured to send datagrams over the interconnect fabric. The transmitter is configured to monitor a loop latency for datagrams communicated between the link partners over the interconnect fabric using toggling handshake codes in their headers. Based on the monitored loop latency for the datagrams, the transmitter of a link partner is configured to reduce a receiver buffer backlog at the other link partner. The loop latency monitoring can include monitoring an unloaded and loaded loop latencies and comparing a difference between the loop latencies to one or more thresholds.

### CROSS-REFERENCE TO RELATED APPLICATIONS

The present application claims the benefit under 35 U.S.C. § 119 of U.S. Provisional Patent Application No. 63/784,317, filed Apr. 7, 2025, and entitled “SYSTEMS AND METHODS FOR ACCURATE LINK LOOP LATENCY MEASUREMENT AND DYNAMIC BACKLOG REDUCTION OF RECEIVER BUFFER,” the entirety of which is herein incorporated by reference.

### BACKGROUND

Accelerators are specialized processing units that are commonly used in computing systems such as, for example, nodes in data centers to perform a wide range of demanding processing or rendering tasks such as, for example, high performance computing (HPC), model training, simulations, graphics rendering, and other applications. Many applications require real-time or near real-time results, which may be provided by multiple processing nodes working together through data communication and resource sharing to perform common tasks using the accelerators. Accordingly, providing high-speed, low-latency communications over an interconnect fabric between accelerators may be desirable to capitalize on the full potential of the accelerators in processing devices.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes it apparent to those skilled in the art how embodiments of the disclosure may be practiced.

FIG. 1 illustrates a block diagram of an example system, according to some embodiments.

FIG. 2 illustrates a diagram of an example system, according to some embodiments.

FIG. 3 illustrates a block diagram of an example system, according to some embodiments.

FIG. 4 is a block diagram of an example computer system, according to some embodiments.

FIG. 5 illustrates a flow diagram of an example system for performing a loop latency measurement, according to some embodiments.

FIG. 6 illustrates a flow diagram of an example system for performing a receiver buffer backlog reduction, according to some embodiments.

FIG. 7 illustrates an example datagram, according to some embodiments.

FIG. 8 is a flow diagram of an example method for measuring loop latency to reduce buffer backlogs, according to some embodiments.

FIG. 9 is a flow diagram of an example method for measuring the first loop latency for data transmissions of datagrams between the two link partners over the at least one interconnect link, according to some embodiments.

FIG. 10 is a flow diagram of an example method for measuring the first loop latency for data transmissions of datagrams between the two link partners over the at least one interconnect link, according to some embodiments.

### DETAILED DESCRIPTION

Described herein are systems and methods for monitoring loop latency during communications between processing units of computing systems over high-speed, low-latency serial links, which may in some embodiments be used to dynamically control receiver buffer backlog by a transmitter side link partner to improve the loop latency. The loop latency monitoring may be implemented in some embodiments by a host computing system located at a transmitter side of the link(s). The loop latency may be continuously monitored by the transmitter side link partner during communications, and the transmitter side link partner can dynamically control the receiver buffer backlog of at least one other computing system located at a receiver side of the physical link. The loop latency measurements and backlog reduction can be implemented in mission mode data transmission without additional overhead or intervention on the link(s), which are the processing tasks assigned to processing units by applications as opposed to other modes of data transmission (e.g., standby, maintenance, or test modes).

Round trip loop latency and receiver buffer backlog are two factors that may affect the performance of high-speed serial interconnect links. Loop latency may determine the size of the transmit buffers and receiver buffers, which may then define a receive window for an amount of data that may be transmitted and not received before the transmission may be interrupted. A receiver buffer backlog may add latency on the link permanently and/or cause overflow if left unaddressed. For example, if too much data is transmitted by the transmitter side link partner, it can overrun the receiver buffer of the receiver side link partner and causes receiver buffer backlog that exceeds the receive window. This backlog may extend the time for communications to arrive at their destination, which can lead to overflows that may cause interruptions in the communications between the link partners. This can lead to lower response rates and thus lowers performance. The loop latency monitoring and dynamic receiver buffer backlog control may in some embodiments be proactively implemented by the transmitter side link partner at the receiver side link partner without providing additional overhead to flow control packets (flits) carrying the data messages and without needing to perform intervention on the link due to the receiver buffer backlog.

The loop latency monitoring may in some examples be implemented by determining an unloaded loop latency and/or an loaded loop latency. The loop latency measurements may in some embodiments be performed by designating one of the two link partners as a master (or “primary”) device and the other of the two link partners as a slave (or “secondary)” device for the purposes of loop latency measurements and integrating two handshake codes (e.g., “HS1” and “HS2”) into a header field of flow control units (flits) being transmitted between the master and slave devices. For example, the master device may initially toggle its code from a default value to a first handshake code (e.g., HS1) in an initial flit header. From this point forward, the slave device may echo the handshake code it receives from the master device in an acknowledgment flit header the slave device sends to the master device. For example, the slave device receives the first handshake code in a flit’s header and sends the first handshake code back to the master device in the flit header of the acknowledgment to the flit carrying the first handshake code in the flit’s header. The master device may toggle the handshake code that it receives in the acknowledgment from the slave device and then may send the toggled handshake code to the slave device in a subsequent flit’s header. Since flits are typically continuously sent between link partners, the loop latency can be continuously measured without adding overhead to the flits transmitted over the link(s) connecting the master and slave devices (e.g., link partners). The loop latency monitoring may also include the transmitter tracking the number of NOP flits (e.g., flits that carry only command and doesn’t go into the receiver buffer) in a history pipeline, which can be taken into consideration when the transmitter determines the degree of backlog in the link partner’s receive buffer and whether to send additional NOP flits to reduce the receive buffer backlog.

The unloaded loop latency may be monitored at a respective side of the physical link, at the master device or the slave device, according to various examples. For example, the time span that the master device sends a code with a new handshake code to the time it sends a code with a toggled handshake code defines a single toggling code loop corresponding to one measurement of the loop latency. This measurement can in some examples be fed to a low pass filter and the filtered result may be an actual unloaded loop latency.

The loaded loop latency may also be monitored using the master device and the slave device. One measurement of the loaded loop latency may in some examples span between a time a flit with a new handshake code is sent by the master device to a time the master device receives an acknowledgment flit with the same handshake code for the same flit from the slave device that is the link partner to the master device. The acknowledgment may in some examples be sent by the slave device when the flit is popped out from the receiver buffer. The transmitter can, based on the comparison between the unloaded loop latency and the loaded loop latency, determine the degree of backlog in the link partner’s receive buffer. That is, the unloaded loop latency is representative of an ideal time that the flits pass over the respective links between the master and slave device without any backlog in the link partner’s receive buffer and the loaded loop latency is the time it takes for the master device to send the flit and for the slave device to send the acknowledgment flit that is then received by the master device, which includes the time it takes for them to pass over the respective links between the master and slave device. Accordingly, the difference between the loaded loop latency and the unloaded loop latency is representative of the latency at the link partner’s receiver buffer and the receiver buffer backlog can thereby be determined based on comparing the loaded loop latency to the unloaded loop latency.

The transmitter may reduce the backlog at the receiver buffer of the receiver by utilizing a latency tracker for tracking and measuring a loaded loop latency for each of the flits sent across the loop based on the toggled handshake codes. The transmitter may maintain a history pipeline that tracks non-operative (NOP) flits. The NOP flits can, in some examples, carry only command instructions and are not loaded onto the receiver buffer. The pipeline can have N number of flits. The transmitter can determine a degree of the backlog in the receiver buffer of the slave device link partner by comparing the unloaded loop latency (T_ref) to the loaded loop latency (T_act) from the latency tracker from the handshake codes, HS1/HS2. The transmitter can utilize the difference between the unloaded loop latency (T_ref) and the loaded loop latency (T_act) relative to a predefined threshold (T_thres0, T_thres1, … T_thresN) for the N number of flits. The transmitter may, taking the number N of recently sent NOP flits into consideration, may determine whether to transmit more NOP flits to the receiver buffer of the link partner’s receiver to reduce the receiver buffer backlog. The latency trackers may in some embodiments be deployed as pre-allocated hardware resources in circuitry that interfaces the device to the serial link.

Different conventional approaches have been proposed for monitoring loop latency and reducing receiver buffer backlog. Some conventional approaches measure loop latency for one loop, or a few loops, statically with training data. However, this static measurement of loop latency is not adaptive and is incapable of accurately reflecting fluctuating circumstances. These conventional approaches are highly sensitive to fluctuations since loop latency may vary per sample (e.g., when replay requests occur). Because of this inaccuracy, these prior approaches may only be suitable for debugging or informational purposes and they cannot be utilized by hardware to dynamically tune the link to improve performance. Some conventional approaches for receiver buffer backlog reduction include the transmitter periodically inserting a “SKIP.” The transmitter’s periodic insertion of these “SKIPs,” are speculative and a fixed link bandwidth is wasted to send the “SKIPs,” thus adding overhead and reducing optimum bandwidth utilization and reducing efficiency. In addition, this requires prior knowledge of the worst possible transmitter/receiver throughput difference to insert a “SKIP” into the design of the physical resources of the transmitter. Some other conventional approaches for receiver buffer backlog reduction requires the receiver to send a request to the transmitter to insert the “SKIP.” The response times for reducing the receiver buffer backlog using these conventional approaches are slow and result in delayed response times, which may necessitate the receiver to be extra pessimistic when deciding to request “SKIPs” from the transmitter and may cause the receiver to unnecessarily send “SKIP” requests to the transmitter to account for the added delay, thereby adding to overhead and bandwidth waste. Yet some other conventional approaches for receiver buffer backlog reduction include the transmitter releases backpressure and drains the remote receiver first in/first out (FIFO) buffer depending on the flow control case. However, the backpressure release may not accurately predict when the remote FIFO buffer is drained, which may result in some bandwidth penalty.

By implementing the loop latency measurement and receiver buffer backlog reduction based on values defined in the flit’s header, the resulting measurements can be utilized to enable the transmitter side host computing device to dynamically resolve receiver buffer backlog in a proactive manner without requiring additional overhead and/or transmission of additional communications between the link partners and without requiring any additional overhead in the datagrams transmitted over the physical link, which improves utilization of the full bandwidth of the flits for data payloads. Further, the receiver buffer backlog reduction mechanisms described herein provide a relatively simple and efficient solution that enables the transmitter to dynamically control the receiver buffer backlog in a manner that is also transparent for the receiver and utilizes a relatively simple handshake mechanism between the link partners that does not require complex control schemes. Enabling the transmitter to intelligently decide when to send NOP flits that is not based on worst case or hardcoded behaviors but rather is based on consideration of relevant factors for a given sample such that the transmitter only inserts the NOP flit as needed preserves the bandwidth for system data and messages, thereby improving the efficiency in data transmissions between devices and/or in systems. Moreover, the receiver buffer backlog reduction mechanisms described herein enables the transmitter to timely make proactive decisions of when to tune the receiver buffer backlog at an earlier time that compared to some of the conventional approaches without incurring some other form of performance and/or overhead penalty.

In some embodiments, an apparatus for monitoring loop latency in communications between link partners includes: at least one circuit coupled between a data fabric of a host device and an interconnect link of an interconnect fabric, the at least one circuit including: a receiver configured to receive datagrams from a link partner over the interconnect fabric, a transmitter configured to send datagrams to the link partner over the interconnect fabric, wherein the transmitter is configured to monitor a loop latency for datagrams communicated with the link partner over the interconnect fabric using toggling handshake codes in a header of the datagrams, and wherein, based on the monitored loop latency for the datagrams, the transmitter is configured to reduce a receiver buffer backlog at the link partner.

In some embodiments, the transmitter is configured to convert a data stream from electrical signals received from the data fabric into datagrams for transmission to the link partner over the interconnect fabric.

In some embodiments, the receiver is configured to convert the datagrams received from the link partner over the interconnect fabric into electrical signals to send to a storage media of the host device over the data fabric.

In some embodiments, monitoring the loop latency includes: monitoring, by the transmitter, an unloaded loop latency for the datagrams; monitoring, by the transmitter, a loaded loop latency for the datagrams; and comparing, by the transmitter, a difference between the unloaded loop latency and the loaded loop latency to one or more thresholds, wherein the transmitter is configured to reduce the receiver buffer backlog at the link partner in response to the difference between the unloaded loop latency and the loaded loop latency exceeding the one or more thresholds.

In some embodiments, monitoring the unloaded loop latency for the datagrams includes: sending, at a first time instance, a first datagram including a first handshake code in the header to the link partner over the interconnect fabric; receiving, at a second time instance, a second datagram including the first handshake code in the header from the link partner over the interconnect fabric; and sending, at a third time instance, a third datagram including a second handshake code in the header to the link partner over the interconnect fabric, wherein the second time instance is after the first time instance, the third time instance is after the first time instance and the second time instance, and the unloaded loop latency includes a difference between the third time instance and the first time instance.

In some embodiments, monitoring the loaded loop latency for the datagrams includes: sending, at a fourth time instance, a fourth datagram including a first handshake code in the header to the link partner over the interconnect fabric; receiving, at a fifth time instance, a fifth datagram including the first handshake code in the header from the link partner over the interconnect fabric, wherein the loaded loop latency comprises a difference between the fifth time instance and the fourth time instance; and determining the receiver buffer backlog derived based on a difference between the loaded loop latency and the unloaded loop latency; wherein the fifth time instance is after the fourth time instance, wherein the sixth time instance is before the fifth time instance, and wherein the fifth time instance includes a latency from the receiver buffer backlog from being generated at a sixth time instance when the link partner acknowledged the fourth datagram.

In some embodiments, reducing the receiver buffer backlog at the link partner includes: generating at least one sixth datagram based on the comparison of the difference between the unloaded loop latency and the loaded loop latency to the one or more thresholds; and sending the at least one sixth datagram to the link partner, wherein each sixth datagram is configured to reduce the receiver buffer backlog at the link partner.

In some embodiments, the transmitter does not package a data payload into each sixth datagram.

In some embodiments, each sixth datagram is configured not to be consumed by the link partner.

In some embodiments, a system for providing loop latency monitoring during communications between link partners includes: a plurality of nodes, each node connected to an interconnect fabric for transmission of datagrams between link partners, each node including: at least one processor coupled to a data fabric; at least one storage media coupled to the data fabric; and at least one circuit coupled between the data fabric and an interconnect link of the interconnect fabric for transmission of data between the data fabric and the interconnect link, the at least one circuit including: a receiver configured to convert datagrams received from a link partner over the interconnect fabric into electrical signals to send to a storage media over the data fabric, and a transmitter configured to convert a data stream from electrical signals received from the data fabric into datagrams for transmission to the link partner over the interconnect fabric, wherein the transmitter is further configured to monitor a loop latency for datagrams communicated with the link partner over the interconnect fabric using toggling handshake codes in a header of the datagrams, and wherein, based on the monitored loop latency for the datagrams, the transmitter is configured to reduce a receiver buffer backlog at the link partner.

In some embodiments, monitoring the loop latency includes: monitoring, by the transmitter, a first loop latency for the datagrams; monitoring, by the transmitter, a second loop latency for the datagrams; and comparing, by the transmitter, a difference between the first loop latency and the second loop latency to one or more thresholds, wherein the transmitter is configured to reduce the receiver buffer backlog at the link partner in response to the difference between the first loop latency and the second loop latency exceeding the one or more thresholds.

In some embodiments, monitoring the first loop latency for the datagrams includes: sending a first datagram including one of a first or second handshake code in the header to the link partner over the interconnect fabric; receiving a second datagram including the one of the first or second handshake code in the header from the link partner over the interconnect fabric; sending a third datagram including the other of the first or second handshake code in the header to the link partner over the interconnect fabric; and determining the first loop latency based on a time span between the sending of the first datagram and the sending of the third datagram.

In some embodiments, monitoring the second loop latency for the datagrams includes: sending a fourth datagram including a first sequence number in the header to the link partner over the interconnect fabric; receiving a fifth datagram including the first sequence number in the header from the link partner over the interconnect fabric; and determining the second loop latency (e.g., loaded loop latency) based on a time span between a time the transmitter sent the fourth datagram and a time the receiver received the fifth datagram; and determining the receiver buffer backlog derived based on a difference between the loaded loop latency and the unloaded loop latency. In some cases, timing of the fifth datagram may incorporate current backlog latency through the link partner receiver buffer.

In some embodiments, reducing the receiver buffer backlog at the link partner includes: generating at least one sixth datagram based on the comparison of the difference between the first loop latency and the second loop latency to the one or more thresholds; and sending the at least one sixth datagram to the receiver buffer of the link partner, wherein each sixth datagram is configured to reduce the receiver buffer backlog at the link partner.

In some embodiments, the transmitter does not package a data payload into the at least one sixth datagram.

In some embodiments, the receiver buffer of the link partner does not consume the at least one sixth datagram.

In some embodiments, a method of utilizing loop latency measurements to reduce buffer backlog during communications between link partners includes: measuring a first loop latency for data transmissions of datagrams between two link partners over at least one interconnect link, a header of the datagrams including one of a first value and a second value; measuring a second loop latency for data transmission of datagrams between the two link partners over the at least one interconnect link; calculating, by a link partner, a value characterizing a degree of a backlog in a receiver buffer of the other link partner based on the measured first loop latency and the measured second loop latency; and responsive to the calculated value exceeding at least one threshold, transmitting, by the link partner, at least one non-operative (NOP) datagram to the other link partner over the at least one interconnect link, the at least one NOP datagram configured to reduce the backlog in the receiver buffer of the other link partner.

In some embodiments, monitoring the first loop latency for the datagrams includes: sending, at a first time instance, a first datagram including a first handshake code in the header to the other link partner over the at least one interconnect link; receiving, at a second time instance, a second datagram including the first handshake code in the header from the other link partner over the at least one interconnect link; and sending, at a third time instance, a third datagram including a second handshake code in the header to the other link partner over the at least one interconnect link, wherein the second time instance is after the first time instance, and the third time instance is after the first time instance and the second time instance, and wherein the first loop latency is determined based on a difference between the third time instance and the first time instance.

In some embodiments, monitoring the second loop latency for the datagrams includes: sending, at a fourth time instance, a fourth datagram including a first handshake code in the header to the other link partner over the at least one interconnect link; receiving, at a fifth time instance, a fifth datagram including the first handshake code in the header from the other link partner over the at least one interconnect link, the second loop latency comprising a difference between the fifth time instance and the fourth time instance; and determining the receiver buffer backlog derived based on a difference between the second loop latency and the first loop latency; wherein the sixth time instance is after the fourth time instance.

In some embodiments, the method further includes: generating the NOP datagram based on a comparison of a difference between the first loop latency and the second loop latency to the at least one threshold; and sending the NOP datagram to a receiver of the other link partner, wherein the link partner does not package a data payload into the NOP datagram, and wherein the NOP datagram is configured to reduce the receiver buffer backlog at the other link partner.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

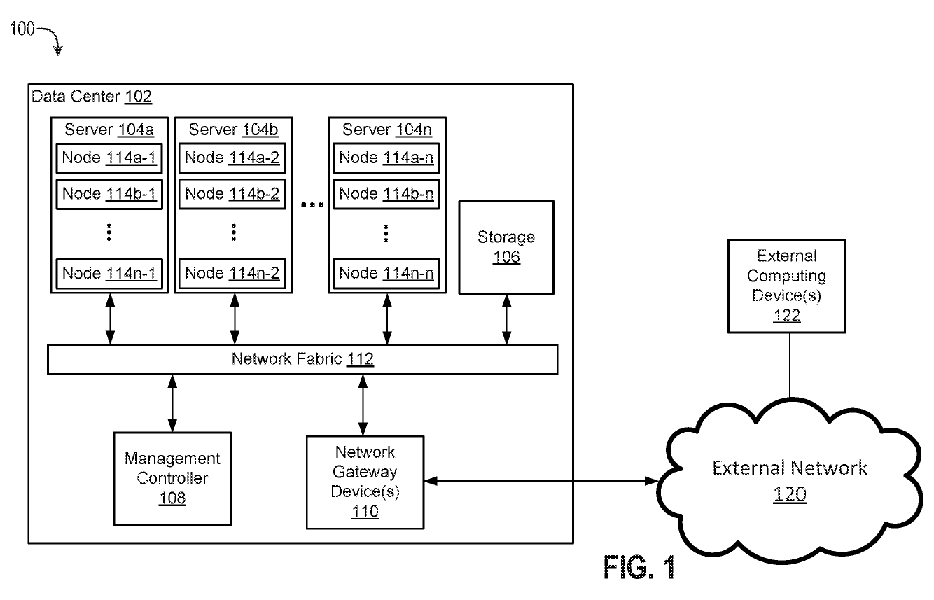

FIG. 1 illustrates a block diagram of an example system 100, according to some embodiments. The system 100 may be configured to implement some techniques described herein, although other systems are possible.

Referring to FIG. 1, the system 100 may include a data center 102. The data center 102 may be communicatively connected to an external network 120. The data center 102 may, for example, receive processing requests from external computing device(s) 122 via the external network 120. The data center 102 may be utilized to perform any of a plurality of processing or rendering tasks based on one or more data sets using at least some portion of a processing and rendering resources of data center 102. For example, a user of an external computing device 122 may send a processing request to data center 102 via external network 120, and the data center 102 may utilize one or more of the processing resources of data center 102 to fulfill the user request. It should be appreciated that FIG. 1 is intended neither to be a depiction of necessary components for a data center or components thereof to operate in accordance with the principles described herein, nor a comprehensive depiction. The system 100 can include additional components, omit one or more of the described components, multiple instances of a component even if only one instance is shown in FIG. 1), and/or can be organized in other suitable manners.

In some examples, the data center 102 may include a plurality of servers 104 (shown as servers 104a-104n), storage device(s) 106, management controller 108, and a network gateway device(s) 110. The plurality of servers 104, storage device(s) 106, management controller 108, and network gateway device(s) 110 may be communicatively coupled with one or more other components of the data center 102 over a network fabric 112.

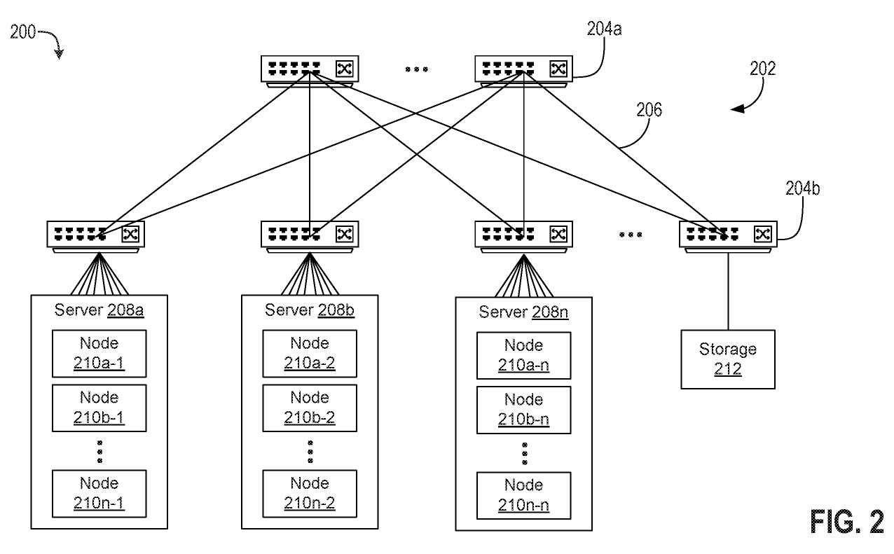

Each server 104 may include a plurality of processing nodes 114 (shown as nodes 114a-114n). Each processing node 114 includes one or more processing resources such as accelerator processing units (APUs), graphics processing units (GPUs), neural processing units (NPUs), tensor processing units (TPUs), field programmable gate arrays (FPGAs), or application specific integrated circuits (ASICs), to perform their processing or rendering tasks, as will be further described herein. While the examples of FIGS. 1 and 2 illustrate servers 104 that include processing nodes 114, each processing node 114 may include individual processing and storage resources and may be directly connected to each other over network fabric 112, such that there may not be any individual element considered to be a server 104 or such that each processing node 114 may be considered a separate server 104.

The storage device(s) 106 may include a variety of computer-readable media for storing data, programs, instructions, etc. for use by the plurality of processing nodes 114 of the plurality of servers 104. For example, storage device(s) 106 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the plurality of processing nodes 114. The storage device(s) 106 can include computer-storage media in the form of volatile and/or nonvolatile memory. The storage device(s) 106 may be removable, non-removable, or any combination thereof. For example, storage device(s) 106 can include hardware devices such as hard drives, solid-state memory, optical-disc drives, and the like.

The management controller 108 may be connected to each of the plurality of servers 104, storage device(s) 106, network gateway device(s) 110. Each of the plurality of servers 104 (shown as servers 104a, 104b, through 104n) may include a plurality of processing nodes 114 (shown as nodes 114a, 114b, through 114n). The management controller 108 may include a combination of hardware, software and firmware to assist in orchestration of processing operations using the plurality of processing nodes 114 at each of the plurality of servers 104, which may include controlling storage, communications, timing, frequency, etc. within the data center 102 and/or between parts of the plurality of servers 104 and other systems (e.g., external client devices).

The network gateway device(s) 110 may communicatively connect data center 102 to external network 120, which may be used to enable external computing device(s) 122 to send processing requests to data center 102, and to receive data from data center 102 responsive to the request via external network 120. For example, network gateway device(s) 110 may receive a processing request from a user of an external computing device 122 via external network 120, and the network gateway device(s) 110 may transmit the request to management controller 108 to orchestrate fulfillment of the request using one or more of the plurality of processing nodes 114 of the plurality of servers 104 in accordance with the user request.

FIG. 2 illustrates a diagram of an example system 200, according to some embodiments. The system 200 may be configured to implement some techniques described herein, although other systems are possible. System 200 may be implemented with any combination of components and/or subsystems of system 100.

It should be appreciated that FIG. 2 is intended neither to be a depiction of necessary components for a data center or components thereof to operate in accordance with the principles described herein, nor a comprehensive depiction. The system 200 can include additional components, omit one or more of the described components, multiple instances of a component even if only one instance is shown in FIG. 2), and/or can be organized in other suitable manners.

In some examples, system 200 may include a network fabric 202 coupled to one or more components including a plurality of servers 208 (shown as servers 208a-208n). The one or more other components may further include any of the components or sub-systems of system 100. Each server 208 may include a plurality of nodes 210 (shown as nodes 210a-210n) for fulfilling processing tasks received from, for example, management controller 108 of FIG. 1. For example, referring to FIG. 2, server 208a is depicted as including nodes 210a-1 through node 210n-1. For example, the one or more other components of system 200 may include storage 212, which may be connected to network fabric 202 to enable the plurality of processing nodes 210 located in the plurality of servers 208 to store data onto storage 212 and to retrieve data from storage 212.

The network fabric 202 may include a plurality of switches 204 (shown as switches 204a, 204b) interconnected together via one or more links 206 such that each switch 204 may be connected to one or more other switches 204, servers 208, and/or nodes 210, or connected to one or more other components of system 200. In some examples, the plurality of switches 204 of network fabric 202 may include spine switches 204a and leaf switches 204b. The spine switches 204a may be connected to one or more leaf switches 204b. The leaf switches 204b may be connected to one or more servers 208, thereby connected a server 208 to one or more spine switches 204a. The leaf switches 204b may serve as an access switch that aggregates data traffic from servers and forwards the data to the spine switches 204a for transmission to its intended destination node. The leaf switches 204b may, in some embodiments, be top-of-rack switches that connects the plurality of processing nodes 210 located in a given server 208 to each other to enable data transmission and resource sharing between the plurality of processing nodes 210 of the given server 208 and/or connects the plurality of processing nodes 210 located in the given server 208 to one or more other nodes 210 located in other servers 208 of the plurality of servers 208 to enable low-latency, high speed data transmission for resource sharing purposes between the nodes 210 of respective servers 208 of the plurality of servers 208.

The links 206 of network fabric 202 may be serial links, which can be utilized for high-speed, low-latency serialized data transmission between at least two components of system 200 over one or more lanes at a pre-defined serial rate. In some examples, one or more of the links 206 may be defined in accordance with 200 Gigabit communication standard, and the one or more links 206 may include 1, 2, 4, or more communication lanes running in parallel for the serialized transmission of data across the lanes between the endpoint nodes, and the lanes may act as a linear multiplier of bandwidth for the serial rate of 212.5 Gbps. In some examples, the links 206 may be designed in accordance with 200 GBASE-KR1/CR1, 400GBASE-KR2/CR2, and/or 800GBASE-KR4/CR4 standards. In some examples, the one or more links 206 may include 2 serial lanes each running at approximately 100 Gigabits of the approximately 200 Gigabit total bandwidth of the links. In some examples, the one or more links 206 may include 4 serial lanes each running at approximately 200 Gigabits of the approximately 800 Gigabit total bandwidth of the links. In some other examples, the one or more links 206 may be defined in accordance with a 100 Gigabit communication standard.

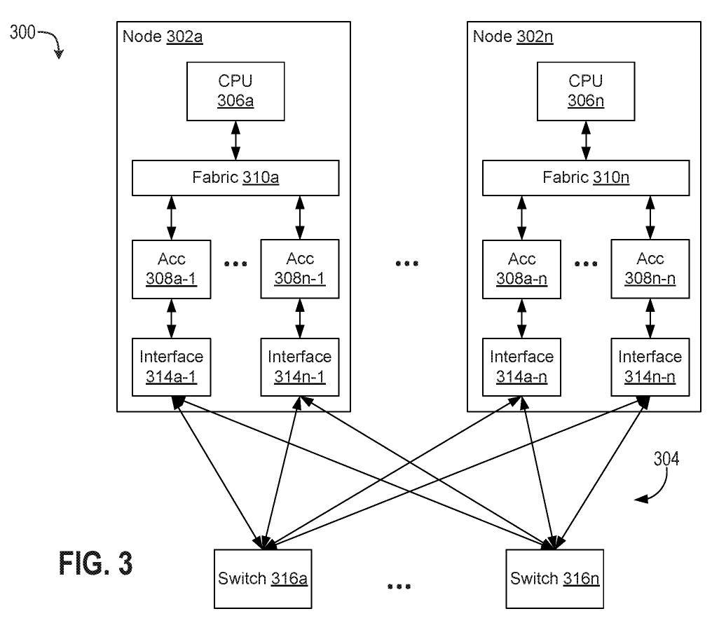

FIG. 3 illustrates a block diagram of an example system 300, according to some embodiments. The system 300 may be configured to implement some techniques described herein, although other systems are possible. System 300 may be implemented with any combination of components and/or subsystems of system 100 and system 200.

System 300 may include one or more processing nodes 302 (shown as nodes 302a-302n). The nodes 302 may correspond to processing nodes 114 of FIG. 1 and/or processing nodes 210 of FIG. 2. Each node 302 may be coupled to one or more other components of system 300 over a network fabric 304. In some examples, each node 302 in system 300 may be connected to one or more other processing nodes 302 over network fabric 304 for data transmission and resource sharing purposes. In some examples, each processing nodes 302 may be selectively utilized to perform a processing or rendering operations either discretely or in parallel with one or more other processing nodes 302 in accordance with some orchestration scheme as determined by, for example, management controller 108 of FIG. 1.

In some examples, each node 302 may include a host central processing unit (CPU) 306 and a plurality of accelerators 308 (shown as acc 308a-308n) communicatively connected to a host fabric 310. The CPU 306 and/or the plurality of accelerators 308 may be communicatively connected to one or more other components of each node 302 to enable the node 302 to exchange data and share resources with one or more other processing nodes 302 when performing the processing tasks. In some embodiments, the CPU 306 and/or the plurality of accelerators 308 may be communicatively connected to the one or more other components of each node 302 via the host fabric 310 or other connection circuitry. In some examples, the CPU 306, the plurality of accelerators 308, and the data fabric 310 may be coupled to (e.g., mounted on) a printed circuit board (e.g., motherboard). In other examples, the CPU 306 and the plurality of accelerators 308 may each be formed on one or more chiplets located on a same package substrate of a system-on-chip and the host fabric 310 may be the die-to-die interconnects to enable high-speed data transmission between the components formed on the individual dies.

The CPU 306 may be configured to process data and execute instructions of an operating system and/or instructions (e.g., program code) of one or more applications. In some examples, the functionality of the program code may be implemented by one or more of the CPU 306, one or more processor chiplets of a CPU 306, and/or one or more cores of a processor chiplet of a CPU 306. The data and instructions can be stored on a memory (not shown) coupled to CPU 306 directly and/or over the host fabric 310. The data and instructions can comprise computer-executable instructions implementing any suitable functionality.

In some examples, as part of executing a given software application, the CPU 306 of a first node 302 launches rendering tasks to be performed by one or more accelerators 308 of the node 302 in parallel with one or more accelerators 308 in each of one or more other nodes 302. It should be appreciated that even though FIG. 3 shows each node as including accelerators 308, the node 302 may instead include other types of specialized components include, for example, a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), other types of processing units or specialized circuitry, or any combination thereof.

In some examples, a host fabric 310 connects CPU 306 and the plurality of accelerators 308 to one or more other components within the node 302. In some examples, the host fabric 310 can be connected to the plurality of accelerators 308 over the host fabric 310. The host fabric 310 may include any type of communication fabric, bus, and/or other control and interface logic for facilitating the communication of data between various components of the node 302. For example, the host fabric 310 may include data paths, switches, routers, controllers, and any suitable control logic to enable high-speed, low-latency data communication between the components, which can then facilitate the high-speed, low latency communications between the nodes 302 across the network fabric 304 including performing the loop latency measurements and the receiver buffer backlog reduction mechanisms described herein. In some embodiments, the host fabric 310 may be bus-based, including shared bus configurations, crossbar configurations, and hierarchical buses with bridges. host fabric 310 may also be packet-based, and can be hierarchical with bridges, crossbar, point-to-point, or other interconnects.

In some examples, each node 302 may further include one or more interface devices 314 (shown as interfaces 314a-314n). The one or more interface devices 314 may communicatively connect the plurality of accelerators 308 of a node 302 to the plurality of accelerators 308 of other node 302 over network fabric 304 for data transmission and resource sharing purposes. For example, the accelerators 308 across multiple nodes 302 can be utilized to perform some resource intensive machine learning or artificial intelligence based processing operation, the multiple nodes 302 including one or more accelerators 308 of node 302a and one or more accelerators 308 of node 302n. In some examples, the one or more interface devices 314 may be network interface cards (“NICs”) or some other type of adapter embodied in circuitry and having physical hardware components for connecting one or more of the plurality of accelerators 308 in each node 302 to the network fabric 304, such that each accelerator 308 can communicatively connect to one or more other components of the system 300. In some examples, interface 314a-1 of node 302a can establish a communication session with interface 304a-n of node 302n so as to enable accelerator 308a-1 to exchange data with accelerator 308a-n over the network fabric 304. In some other examples, interface 314a-1 of node 302a can establish a communication session with interface 304a-n of node 302n over the network fabric 304 so as to enable accelerator 308a-1 to write data directly onto a memory or other storage media of node 302n or read data directly from the memory or other storage media of node 302n. In some examples, network fabric 304 may include a plurality of switches 316 (shown as switches 316a-314n), and each node 302 may be in communicable connection with one or more of the switches 316. In some examples, the interfaces 314 may enable the communicable connection of each accelerator 308 in the node 302 to one or more switches of the plurality of switches 316 for redundancy purposes, alternative network path routing, etc., to provide multiple logical routing paths between the accelerators 308 in one node 302 and the accelerators 308 in other nodes 302 of the plurality of nodes 302 of system 300.

It should be appreciated that FIG. 3 is intended neither to be a depiction of necessary components of the nodes 302 and/or components thereof to operate in accordance with the principles described herein, nor a comprehensive depiction. The nodes 302 may include additional components, omit one or more of the described components, include multiple instances of a component even if only one instance is shown in FIG. 3, and/or can be organized in other suitable manners. In some examples, each node 302 may include at least one circuit having any suitable combination of hardware components to provide each accelerator 308 with an interface 314 the connects to the network fabric 304. Accordingly, an interface 314 coupled to an accelerator 308 in a host device can establish a communication session with another interface 314 coupled to another accelerator 308 in a target device to enable the exchange of data between the two devices when performing the processing tasks in a mission mode.

It should be appreciated that system 300 of FIG. 3 may further include one or more interface devices (e.g., NICs, adapters, etc.), and each CPU 306 may be connected to a respective interface device to enable front-end communication between the node 302 and one or more other components (e.g., other nodes, controllers, memory, etc.) of system 300 over the network fabric 304. For example, management controller 108 may send processing instructions to CPU 306 through the respective interface device. In some examples, the at least one circuit of each node 302 can include the necessary hardware components to provide the CPU 306 with an interface device to enable the front-end communications.

It should be appreciated that FIG. 3 is intended neither to be a depiction of necessary components for the nodes 302 and/or the network fabric 304 of system 300, or components thereof to operate in accordance with the principles described herein, nor a comprehensive depiction. The system 300 can include additional components, omit one or more of the described components, multiple instances of a component even if only one instance is shown in FIG. 3, and/or can be organized in other suitable manners.

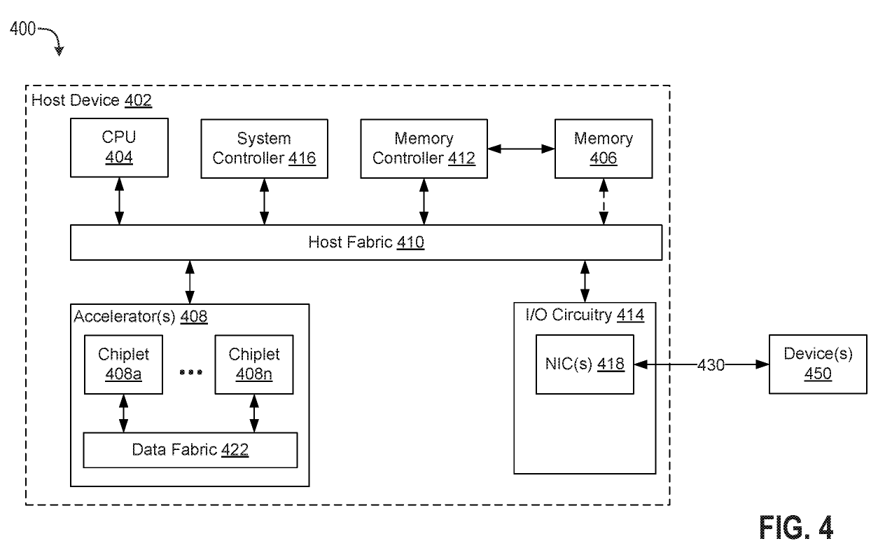

FIG. 4 is a block diagram of an example computer system 400, according to some embodiments. The computer system 400 may be configured to implement some techniques described herein, although other systems are possible. Computer system 400 may be implemented with any combination of components and/or subsystems of system 100, system 200, and system 300.

The computer system 400 may include a host device 402, which can be or otherwise be included within, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. It should be appreciated that FIG. 4 is intended neither to be a depiction of necessary components for a computer system or device to operate in accordance with the principles described herein, nor a comprehensive depiction. The computer system 400 can include additional components, omit one or more of the described components, multiple instances of a component even if only one instance is shown in FIG. 4), and/or can be organized in other suitable manners.

In some examples, the computer system 400 may include a plurality of devices including the host device 402 and one or more other devices 450 connected to each other over a network fabric 430. Each of the plurality of devices may include one or more components similar to host device 402. In some examples, host device 402 may include a central processing unit (CPU) 404, a system memory 406, and one or more accelerators 408, all communicatively attached to host fabric 410 (or other connection circuitry). In some examples, the CPU 404, system memory 406, accelerator 408, and host fabric 410 are coupled to (e.g., mounted on) a printed circuit board (e.g., motherboard).

The CPU 404 can include any combination of processing units, for example, one or more processor chiplets, each including one or more cores. In some examples, the processor chiplets (or other processing units) can communicate with each other via interconnects routed through or on a package substrate. The CPU 404 is configured to process data and execute instructions of an operating system and/or instructions (e.g., program code) of one or more applications. The one or more applications can be utilized to distribute processing tasks to the accelerator 408 such as during HPC applications, machine learning training applications, data processing applications, etc. In some examples, the functionality of the program code may be implemented by one or more of the CPU 404, one or more processor chiplets of a CPU 404, one or more cores of a processor chiplet, and/or the accelerator 408. The data and instructions can be stored on system memory 406 and/or some other storage media (not shown). The data and instructions can, in some examples, be stored on computer-readable storage media (e.g., system memory 406, registers, internal or external of the CPU 404, caches of the accelerator 408, other storage media, etc.) and the instructions can comprise computer-executable instructions implementing any suitable functionality including the loop latency monitoring and receiver buffer backlog reduction mechanisms described herein.

The system memory 406 can include a variety of computer-readable media for storing data, programs, instructions, etc. for use by the host device 402. For example, system memory 406 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the CPU 404 and/or the accelerator 408. The system memory 406 can include computer-storage media in the form of volatile and/or nonvolatile memory. The system memory 406 may be removable, non-removable, or any combination thereof. For example, system memory 406 can include hardware devices such as hard drives, solid-state memory, optical-disc drives, and the like.

In some examples, as part of executing a given software application, the CPU 404 launches rendering tasks to be performed on the accelerators 408. The accelerators 408 can include one or more graphics processing units (GPUs), accelerated processing units (APUs), vision processing units (VPUs), tensor processing units (TPUs), physics processing units (PPUs), digital signal processing (DSP) circuits, field programmable gate arrays (FPGAs), application-specific integrated circuits (ASICs), etc., or a combination thereof.

In some examples, a host fabric 410 connects CPU 404, system memory 406 (directly of via one or more memory controllers 412), accelerators 408, I/O circuitry 414 (and NICs 418), and other components to each other within the host device 402. The host fabric 410, can include any type of communication fabric, bus, and/or other control and interface logic for facilitating the communication of data between various components of the host device 402. For example, the host fabric 410 can include data paths, switches, routers, and other logic used to communicate data among the various components. In some embodiments, the host fabric 410 can be bus-based, including shared bus configurations, crossbar configurations, and hierarchical buses with bridges. Host fabric 410 can also be packet-based, and can be hierarchical with bridges, crossbar, point-to-point, or other interconnects. The host fabric 410 is configured to route memory access requests and memory responses between any memory accessing components and/or the one or more memory controllers 412. The host fabric 410 can also include a system memory map (e.g., defined by BIOS) for determining destinations of memory accesses based on the system configuration.

In some examples, the host device 402 includes a system controller 416 which serves as a system management circuit. Each of the CPU 404, the system memory 406 (directly of via one or more memory controllers 412), the accelerator 408, host fabric 410, and the I/O circuitry 414 can be bidirectionally connected to the system controller 416 (or power management controller), which forms a control fabric for sending control messages to one or more other components of host device 402 and/or to other devices or systems in computer system 400. The system controller 416 may include any suitable combination of hardware, software and/or firmware to assist in controlling storage, communications, timing, frequency, temperature, other parameters, etc. within the host device 402 and/or between parts of the host device 402 and other devices or systems (peripherals, devices 450, accelerators, switches, routers, other devices, etc.) in computer system 400.

The one or more memory controllers 412 are configured to control the flow of data to and from the system memory 406. For example, the memory controller(s) 412 can handle the reading and writing of data to and from the system memory 406, schedule access to the system memory 406 to optimize bandwidth and latency, detect and correct errors in data stored in memory, translate logical addresses into physical addresses, adjust the use of available memory bandwidth to maximize performance, among other tasks.

In some examples, the I/O circuitry 414 may be configured to physically and communicatively connect the CPU 404, the accelerator 408, the system memory 406, or other components of host device 402 with one or more components in the one or more other devices 450 or other devices, peripherals, systems. etc., of computer system 400. In some examples, the I/O circuitry 414 may include a network interface card (NIC) 418 to connect the host device 402 to the network fabric 430 to enable the accelerators 408 of host device 402 to establish communication sessions with accelerators in the one or more other devices 450 across the network fabric 430 to exchange data between the devices. In some examples, the I/O circuitry 414 includes the NIC(s) 418. In other examples, the NIC 418 may be a standalone card or circuit separate from the I/O circuitry 414.

In some examples, the I/O circuitry 414 and/or the NICs 418 can include a transmitter (Tx) for transmitting data packets to a link partner over the links of network fabric 430 and a receiver (Rx) for receiving data packets from the link partner over the links of the network fabric 430. The data packets can be operational commands, memory requests, memory responses, acknowledgments, NOP messages, other messages, in accordance with the techniques described herein. The I/O circuitry 414 and/or the NIC 418 can serve as an interface that bridges sending and receiving data based on instructions from the applications running at a software level at the host device 402 to the physical transmission and storage of the data over the network fabric 430 by the I/O circuitry 414 and/or the NICs 418.

In some examples, the I/O circuitry 414 may be configured to physically connect to peripheral devices and control the flow of data to and from the system memory 406 and/or storage. Some non-limiting examples of an input device can include a mouse, keyboard, scanner, video game controller, microphone, webcam, etc. Some non-limiting examples of an output device can include a display, printer, speakers, headphones, earbuds, etc. The I/O circuitry 414 can include any suitable type of peripheral connector(s), including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc. In some examples, portions of the I/O circuitry 414 can be integrated into a motherboard and/or motherboard chipset (e.g., I/O circuitry 414) of the host device 402.

As described above, host device 402 may have one or more components and peripherals, including input and output devices. These devices may be used, among other things, to present a user interface. Examples of output devices that can be used to provide a user interface include display screens for visual presentation.

In some examples, the accelerator 408 may include any combination of processing units, for example, one or more processor chiplets, each including one or more cores. In some examples, the processor chiplets (or other processing units) can communicate with each other via a data fabric 422 comprising interconnects internally routed between each of the chiplets 408a through 408n of accelerator 408. The interconnects may in some embodiments be routed through or on a package substrate to connect the chiplets 408a. The accelerator 408 may be configured to process data and execute instructions of CPU 404 and/or instructions (e.g., program code) of one or more applications. In some examples, the functionality of the program code may be implemented by one or more of the accelerator 408, one or more processor chiplets of accelerator 408, one or more cores of a processor chiplet, and/or the CPU 404. The data and instructions may be stored on system memory 406 and/or memory (not shown). The data and instructions stored on any of the computer-readable storage media (e.g., system memory 406, registers, internal or external of the CPU 404, caches of the processing units 406,408, etc.) can comprise computer-executable instructions implementing any suitable functionality.

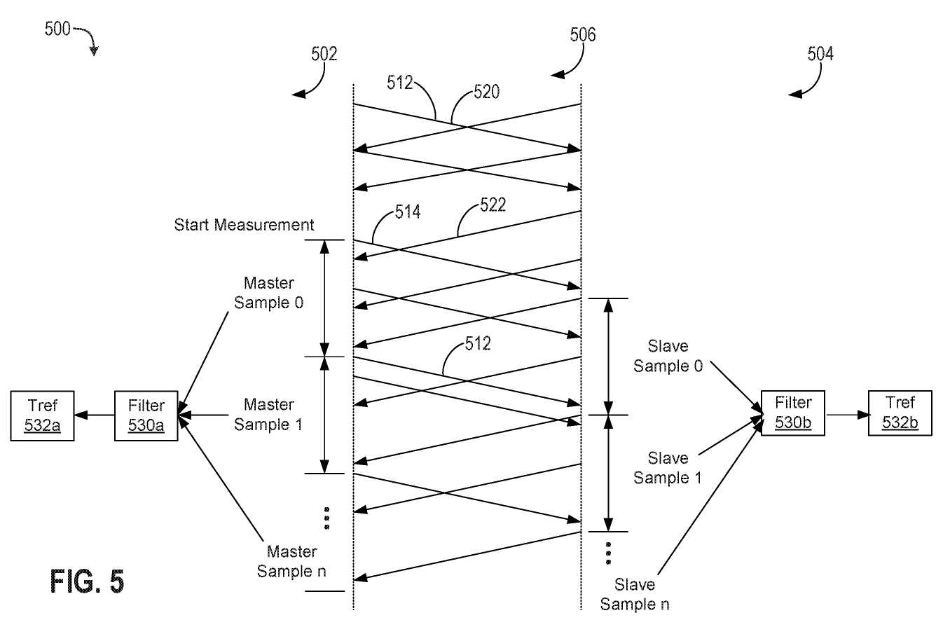

FIG. 5 illustrates a flow diagram of an example system 500 for performing a loop latency measurement, according to some embodiments. The system 500 may be implemented using some techniques described herein, although other methods are possible. The system 500 may be implemented with any combination of components and/or subsystems of system 100, system 200, system 300, and/or computer system 400.

The loop latency measurement performed in system 500 may involve data transmission between link partners over one or more serial links 506 of a network fabric. The network fabric may in some examples correspond to network fabric 304. The network fabric may in other examples correspond to network fabric 430 of FIG. 4. The link partners may include a first computing system 502 and a second computing system 504. The first computing system 502 may in some examples be a master device and the second computing system 504 may be a slave device. The first computing system 502 and the second computing system 504 each may include an interface that includes at least one circuit that is coupled to a data fabric and is coupled to a link 506 of the network fabric. The interface may in some examples correspond to one or more interface devices 314 of FIG. 3 and/or NIC 418 as shown in FIG. 4. The interface encodes electrical signals received from the data fabric into datagrams (e.g., flits) for transmission over the one or more serial links 506 to the link partner, and decodes the datagrams received over the one or more serial links 506 from the link partner and sends the data payload as electrical signals to one or more other components of the computing system.

In some examples, the at least one circuit may include one or more interfaces, each interface including a transmitter and a receiver to enable a respective processing unit in each link partner to exchange data over the one or more serial links 506. The transmitter may send the flits 520 (e.g., datagrams) to the link partner over the one or more serial links 506. The receiver may receive the flits 520 from the link partner over the one or more serial links 506. In some embodiments, the interface may include circuitry hardware components designed to package the electrical signals received from the data fabric into flits 520, and the transmitter can send the flits 520 to the link partner over the one or more serial links 506 as encoded datagrams. In some embodiments, the receiver may receive the flits 520 (or encoded datagrams) from the one or more serial links 506, and the interface may include circuitry hardware components designed to decode the datagrams into flits 520 and unpack the data from the commands and send them as electrical signals over the data fabric to its intended destination (e.g., memory or other storage location).

Referring to FIG. 5, a portion of a communication session between a transmitter of first computing system 502 (e.g., master device) and a receiver of second computing system 504 (e.g., slave device) is depicted. The first computing system 502 may measure a loop latency during the communications with the second computing system 504 using handshake codes integrated into the headers of flit 520 commands. The loop latency measurement may in some examples include defining a field in a flit header of each flit 520 to include one of the first handshake code 512 and the second handshake code 514. In the flits 520 sent to the receiver of the second computing system 504 over the one or more serial links 506, the transmitter of the first computing system 502 toggles the field in the flit headers between the first handshake code 512 and the second handshake code 514 based on the handshake code in the flit headers of the acknowledgement flits 522 received from the second computing system 504. In some examples, the first handshake code 512 may be represented as HS1 and the second handshake code 514 may be represented as HS2.

In some examples, the transmitter of the first computing system 502 may send a flit 520 including a first handshake code 512 in its flit header to the second computing system 504. The receiver of the second computing system 504 may receive the flit 520, generate an acknowledgment flit 522 that integrates the first handshake code 512 into the flit header of the acknowledgment flit 522, and the transmitter of the second computing system 504 may send the acknowledgment flit 522 to the first computing system 502. The second computing system 504 may in some examples perform some action based on the data payload of the flit 520 received from the first computing system 502 prior to sending the flit 522 to the first computing system 502. The receiver of the first computing system 502 may receive the acknowledgment flit 522 and triggers the toggling of the handshake code from the first handshake code 512 to the second handshake code 514 that the transmitter of the first computing system 502 integrates into the flit header of a next flit 520 that is sent to the second computing system 504 over the one or more serial links 506, and so forth for each flit communicated between the link partners. Integrating the handshake codes into the flit headers of the flits enables performing the loop latency measurement without incurring additional overhead on the available data width of the one or more serial links 506.

In some examples, one of the link partners may be designated as loop latency measurement master/primary (left side of FIG. 5) and the other link partner may be designated as slave/secondary (right side of FIG. 5). The master or the slave may be utilized to initiate an unloaded loop latency monitoring. The unloaded loop latency monitoring may in some examples be performed at the master by toggling a code at the flit header from the default value in mission mode to a first value characterizing the first handshake code 512 and the master sending the flit 520 including the first value in the flit header to the slave. For example, the master may toggle the code from the default value to HS1 and send the flit 520 including the HS1 code to the slave. The slave receives the flit 520 including the first value in the flit header from the master and toggles a handshake code of a flit header of a subsequent flit 522 to the first value and sends the flit 522 including the first value to the master. For example, the slave may receive the HS1 code in a flit 520 and may toggle the code of a flit header of an acknowledgment flit 522 to HS1 and sends the acknowledgment flit 522 to the master over the links. The master receives the acknowledgment flit 522 having the first value in the flit header and toggles the handshake code from the first value to the second value.

The time span between the instant the master sends flit 520 having the first value and the instant that the master sends a next flit 520 having the second value toggled from the first value to the slave defines one toggling code loop that corresponds to one measurement of the unloaded loop latency. For both the master and slave, the duration of the time period between when it sends a given handshake code in a flit to its link partner to when it sends a toggled handshake code in a subsequent flit to its link partner may be a sample measurement (e.g., cycle) of the loop latency. At the respective side of the link partners, the measurements may be provided to a low-pass filter 530 (shown as filters 530a, 530b) of the respective first computing system 502 and second computing system 504, and the filtered result may represent an actual unloaded loop latency 532 (shown as T_ref 532a, 532b) of the respective first computing system 502 and second computing system 504. The low-pass filters 530 may filter out sporadic, inaccurate samples to improve the accuracy of the unloaded loop measurement (T_ref) made by the master, or first computing system 502. The unloaded loop latency 532 may in some examples be representative of a reference time for the flits with the toggled handshake code to cycle the loop without any backlog at a receiver buffer of the slave, or second computing system 504.

Since flit sending may be continuous for different communication protocols (e.g., UAlink, PCIe, etc.), the loop latency measurement techniques described herein enables continuous monitoring of loop latency using toggled handshake codes without any added overhead over the one or more serial links 506.

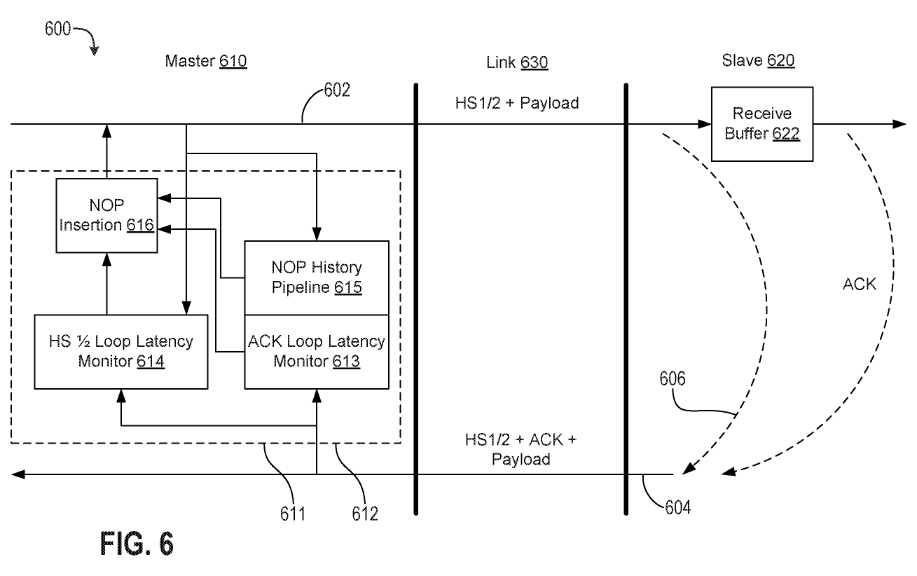

FIG. 6 illustrates a flow diagram of an example system 600 for performing a receiver buffer backlog reduction, according to some embodiments. The system 600 may be implemented using some techniques described herein, although other methods are possible. The system 600 may be implemented with any combination of components and/or subsystems of system 100, system 200, system 300, computer system 400, and/or system 500.

System 600 includes a master 610 and a slave 620 forming a link pair. The master 610 may be communicative connected to slave 620 over links 630. The links 630 may correspond to links of a network fabric 202 of FIG. 2, network fabric 304 of FIG. 3, and/or network fabric 430 of FIG. 4. The links 630 may correspond to one or more serial links 506 of FIG. 5. The master 610 may perform a receiver buffer backlog reduction at the slave 620, as will be further described herein.

Master 610 includes a transmitter 611. The transmitter 611 may send flits 602 to a receiver of the slave 620 over the links 630. The flits 602 may in some examples include a data payload and a flit header, the flit header including a field for a toggling handshake code including a first handshake code and a second handshake code. The transmitter 611 may deploy a loop latency tracker 612 for the flit sent to the slave 620 over the links 630. The transmitter 611 may in some examples deploy a loop latency tracker 612 for each flit sent to the slave 620 over the links 630. The number of loop latency trackers 612 that the transmitter 611 may have may be determined based on the pre-allocated hardware resources in the at least one circuit that includes the transmitter 611.

The latency tracker 612 of the transmitter 611 includes an ACK loop latency monitor 613, a handshake loop latency monitor 614, a NOP history pipeline 615, and a NOP insertion mechanism 616, which can be utilized in some examples to reduce the receiver buffer backlog in the receiver of the slave 620.

The ACK loop latency monitor 613 monitors a loaded loop latency (T_act) for flits communicated between the master 610 and the slave 620 over the links 630. The loaded loop latency may in some examples be measured based on a time a flit 602 with a given handshake code (HS1ₐ or HS2ₐ) is sent to the slave 620 and the time the flit 604 representative of the acknowledgment of the flit 602 sent by the slave 620 is received by the master 610, having been popped out of the receive buffer 622 for consumption. The slave 620 acknowledges the flit 602 by sending acknowledgement flit 604 with same given handshake code (HS1ₐ or HS2ₐ) as in flit 602 to the master 610. The slave 620 may be considered to have acknowledged the flit 602 when the acknowledgement flit 604 is popped out from a receiver buffer 622 of the receiver of the slave 620. The acknowledgement flit 604 may in some examples be encoded with data in its flit header with information of when the acknowledgement flit 604 is popped out from a receiver buffer 622 of the receiver of the slave 620.

The handshake loop latency monitor 614 monitors an unloaded loop latency (T_ref) for flits communicated by the master 610 based on the handshake codes HS1ᵤ/HS2ᵤ in the flit 602 or the flits communicated by the slave 620 based on the HS1ᵤ/HS2ᵤ echoes 606 in the acknowledgment flits 604. The unloaded loop latency (T_ref) may correspond to the unloaded loop latency (T_ref) described with regard to system 500 of FIG. 5. Accordingly, in some examples, each loop measurement at master 610 starts at an instant when the master 610 sends a flit 602 having the first handshake code (HS1ᵤ) or second handshake code (HS2ᵤ) in the flit header to the slave 620 and ends at an instant when the master 610 sends a subsequent flit 602 having the other of the first handshake code (HS1ᵤ) or second handshake code (HS2ᵤ) in the flit header to the slave 620. When it receives acknowledgement flit 604 from slave 620 with the first handshake code (HS1ᵤ) or second handshake code (HS2ᵤ), the master 610 may in some examples toggles the handshake code of the next flit 602 to the other of the first or second handshake code, which corresponds to one measurement of the unloaded loop latency. At slave 620, the one loop measurement may in some examples start at an instant when the slave 620 sends an acknowledgment flit 604 including one of the first or second value in the flit header to the master 610 and ends at an instant when the slave 620 sends a subsequent acknowledgement flit 604 having the other of the first or second value in the flit header to the master 610, which is an echo of the handshake code in the header of the flit 602 received from the master 610.

The NOP history pipeline 615 records a certain number of the most recent NOP flits (flit that only carry commands and do not go into receiver buffer 622) that were sent to the receiver of the slave 620. The number of NOP flits in the pipeline may be represented as an integer number "N".

The loop latency tracker 612 may in some examples determine the degree of the backlog in the receiver buffer 622 of the slave 620 by comparing the unloaded loop latency (T_ref) from the handshake loop latency monitor 614 to the loaded loop latency (T_act) from the ACK loop latency monitor 613. The transmitter 611 may in some examples compare the difference between the unloaded loop latency (T_ref) and the loaded loop latency (T_act) to a set of predefined thresholds (T_thres0, Tthres1... TthresN) to determine whether to utilize NOP insertion mechanism 616 to insert a NOP flit that master 610 may in some examples send to the slave 620 to reduce the backlog at the receiver buffer 622. Because the unloaded loop latency is representative of an ideal time for flits to pass over their respective links without any backlog at the receiver buffer of the slave 620 determined from the toggling of the handshake codes in the header by the master 610, and because the loaded loop latency is representative of the time that it takes for the flit 602 sent by master 610 and flit 604 sent in acknowledgement to flit 602 (having been popped from receive buffer 622) to pass over the respective links and be received by the master 610, the difference between the loaded loop latency and the unloaded loop latency is inherently representative of a latency from the backlog at the receiver buffer 622 at the slave 620. Accordingly, the receiver buffer 622 backlog can be inferred based on the difference between the loaded and unloaded loop latencies.

The number "N" of recently sent NOP flits may in some examples be monitored by the NOP history pipeline 615 and utilized in determining whether NOP insertion mechanism 616 inserts a NOP flit that master 610 sends to the slave 620 to reduce the backlog at receiver buffer 622. The backlog reduction mechanism may inject NOP flits that are then deposited into the receiver buffer 622 based on the determination from the loop latency monitoring and/or the monitoring of the NOP history pipeline 615. Each NOP flit consumes time on the link from its transmission, but does not consume time in the receive buffer. Accordingly, each NOP flit will result in some latency reduction if there is a backlog in the receiver buffer 622. The recent NOPs in the NOP history pipeline 615 are monitored to determine whether the desire to reduce the backlog at the receiver buffer 622 will have already been satisfied by the existence of an adequate number of recent NOP FLITs having been transmitted on the pipeline. If true, then there may not be a need for the NOP insertion mechanism 616 to issue further NOP FLITs, which will waste bandwidth opportunities. However, if an inadequate number of NOPs have been recently issued, the NOP insertion mechanism 616 of the transmitter 611 can inject new NOP FLITs (and burn the associated bandwidth opportunity) to force the backlog reduction at the receiver buffer 622.

The receiver buffer backlog reduction mechanism provided by the loop latency tracker 612 of the transmitter 611 of master 610 provides an adaptive solution that measures loop latency in a way that converges to the latest configuration or topology of the links 630 between the master 610 and the slave 620 even though the loop latency may change with each different link configurations or topologies. Because of this, the receiver buffer backlog reduction mechanism provided by the loop latency tracker 612 of the transmitter 611 can predict when to insert NOP flits into the continuous stream of flits being communicated from the master 610 to the slave 620 that dynamically adapts to the link status and is controlled by the transmitter 611 of the master 610 in a transparent manner for the receiver of the slave 620.

The loaded and unloaded loop latency monitoring is described in the context of first and second handshake codes for ease of description purposes. It should be appreciated that the flit headers of the flits can include these and other values such as, for example, sequence numbers, hashes, keys, etc., that each flit can be tagged with for the purposes of, for example, loaded loop latency monitoring, and the loaded loop latency monitoring resources may track the sequence numbers from launch to retirement (e.g., when the flit is popped from the receive buffer after any backlog that has preceded it is pulled from the buffer). It should also be appreciated that the number of latency measurement resources that are provided may in some examples determine the intervals at which the loaded loop latency feedback can be expected to be received.

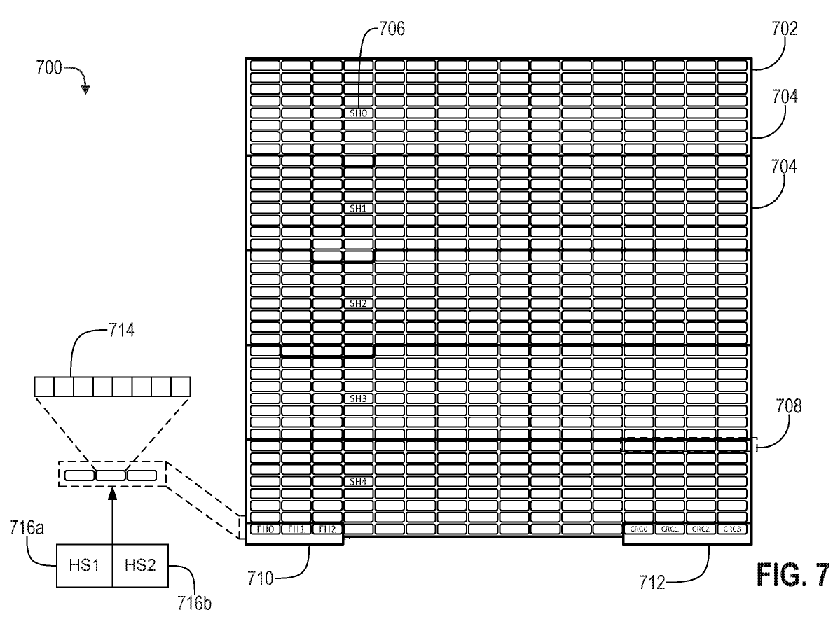

FIG. 7 illustrates an example datagram 700, according to some embodiments. The datagram 700 may be implemented in accordance with some techniques described herein, although other control data packets are possible. Datagram 700 may in some examples be a flit, which may be implemented with any combination of components and/or subsystems of system 100, system 200, system 300, computer system 400, system 500, and/or system 600.

The datagram 700 may be a flit 702. The flit 702 may include n number of data segments 704. Each data segment 704 of the n number of data segments 704 may include a segment header 706 (shown as SH0, SH1, SH2, SH3, and SH4) and m number of sectors 708, with each sector 708 having a predefined number of bytes. For example, each sector may include 32-bytes. The segment header 706 may describe the data that starts in the data segment 704. The m number of sectors 708 may be for packing a data payload. The flit 702 may in some examples be a DL flit. The flits 702 may be utilized to support low-latency, high-speed communications of read, write, and atomic transactions across nodes or computing devices across a specific set of interconnects. The interconnects can include, for example and without limitation, CXL, PCIe, XGMI, CHI c2c, Aulin, and Infinity Fabric, although other interconnect fabrics may be possible.

The flit 702 may also include a flit header 710 and a CRC 712 that may be appended to the flit 702 such that one or more of the data segments 704 may include less than m number of sectors 708 for packing the data payload. The flit header 710 may include one or more fields to indicate the type of data and sequence number of the flit 702 to aid in link level replay, and other information. The flit header 710 may include one or more fields to indicate the type of data in the payload, whether the payload is an original transmission or replay flit, and when the payload is for a NOP flit. The flit header 710 may include a field 714 that includes a handshake code 716 that may be toggled between a first handshake code 716a and a second handshake code 716b. The handshake code 716 enables the flits 702 to be utilized to monitor loop latency and to reduce the receiver buffer backlog in a receiver of a slave device by a master device. The CRC 712 may be a calculated value characterizing the contents of the flit 702. The flit 702 may in some examples be a command flit and the flit header 710 may be a command flit header including one or more fields to indicate the type of data in the payload, whether the payload is an acknowledgment, a replay request, or some other request, whether the payload is for a NOP flit, sequence number of the flit 702, and the lower bit values of the flit sequence number.

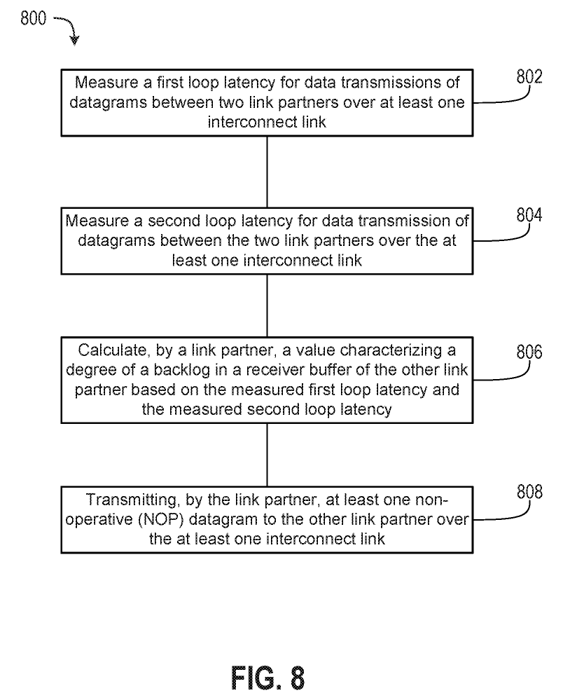

FIG. 8 is a flow diagram of an example method 800 for measuring loop latency to reduce buffer backlogs, according to some embodiments. The method 800 may be implemented in accordance with some techniques described herein, although other methods are possible. Method 800 may be implemented with any combination of components and/or subsystems of system 100, system 200, system 300, computer system 400, system 500, system 600, and/or datagram 700.

At 802, the method 800 may include measuring a first loop latency for data transmissions of datagrams between two link partners over at least one interconnect link. A header of the datagrams may in some embodiments include one of a first value or a second value. The datagram header may include a field that can be toggled between the first value and the second value. The first value may in some examples be a first handshake code. The second value may in some examples be a second handshake code. To begin monitoring the first loop latency, the datagram header may in some examples be initially toggled from a default value in the mission mode to one of the first value or the second value. Subsequent datagrams during the loop latency monitoring may then be toggled between the first value and the second value. The first loop latency may correspond to the unloaded loop latency described with respect to system 600 of FIG. 6.

At 804, the method 800 may include measuring a second loop latency for data transmission of datagrams between the two link partners over the at least one interconnect link. To begin monitoring the second loop latency, the datagram header may in some examples be initially toggled from a default value in the mission mode to one of the first value or the second value. Subsequent datagrams during the loop latency monitoring may then be toggled between the first value and the second value. The second loop latency may correspond to the loaded loop latency described with respect to system 600 of FIG. 6.

At 806, the method 800 may include calculating, by a link partner, a value characterizing a degree of a backlog in a receiver buffer of the other link partner based on the measured first loop latency and the measured second loop latency. The link partner may in some embodiments be a first computing device connected to the interconnect fabric and the other link partner may be a second computing device connected to the interconnect fabric. The link partner may in some examples be a master device and the other link partner may be a slave device. The value characterizing the degree of the backlog in the receiver buffer of the other link partner may in some embodiments be based on a comparison between a difference between the first loop latency and the second loop latency to at least one threshold. The calculation of the value characterizing the degree of the backlog in the receiver buffer of the other link partner is described with regard to system 500 of FIG. 5 and system 600 of FIG. 6.

At 808, the method 800 may include responsive to the calculated value exceeding at least one threshold, transmitting, by the link partner, at least one non-operative (NOP) datagram to the other link partner over the at least one interconnect link. The at least one NOP datagram may in some embodiments be configured to reduce the backlog in the receiver buffer of the other link partner. The at least one NOP datagram is described with respect to NOP insertion mechanism 616 of FIG. 6.

The method 800 may further include in some embodiments generating the NOP datagram based on a comparison of a difference between the first loop latency and the second loop latency to the at least one threshold and sending the NOP datagram to a receiver of the other link partner. The link partner does not package a data payload into the NOP datagram. The NOP datagram may be configured to reduce the receiver buffer backlog at the other link partner.

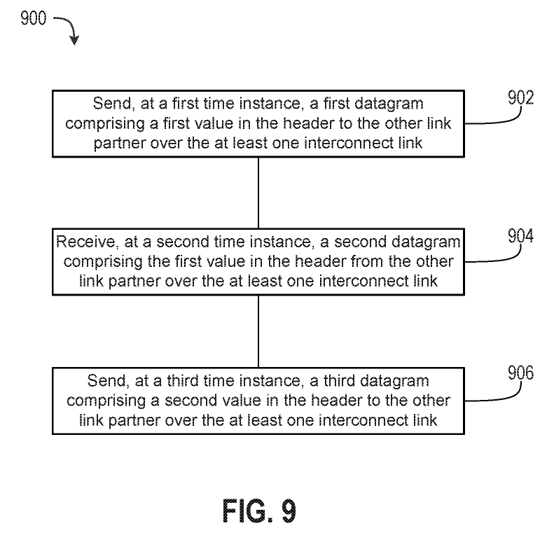

FIG. 9 is a flow diagram of an example method 900 for measuring the first loop latency for data transmissions of datagrams between the two link partners over the at least one interconnect link, according to some embodiments. The method 900 may be implemented in accordance with some techniques described herein, although other methods are possible. Method 900 may be implemented with any combination of components and/or subsystems of system 100, system 200, system 300, computer system 400, system 500, system 600, and/or datagram 700. Method 900 may be an embodiment of 802 of method 800.

At 902, the method 900 may include sending, at a first time instance, a first datagram including a first value in the header to the other link partner over the at least one interconnect link. In some embodiments, the first datagram may include one of the first value or the second value in the header. In some embodiments, the first datagram may be a set of first datagrams of a message being communicated between the two link partners, and the link partner may toggle between the first value and the second value in the header of each first datagram. The link partner may in some examples toggle the header field to one of the first value or the second value based on an immediately prior second datagram received from the other link partner including the other of the first value or the second value in the header. In some embodiments, the first datagram may be for a read, write, or atomic message being communicated between the two link partners. In some embodiments, the first datagram may be a command datagram being communicated between the two link partners.

At 904, the method 900 may include receiving, at a second time instance, a second datagram comprising the first value in the header from the other link partner over the at least one interconnect link. In some embodiments, the second datagram may include the one of the first value or the second value in the header. In some embodiments, the second datagram sent by the other link partner may be an acknowledgement datagram sent in response to an immediately prior first datagram received from the link partner including one of the first value or the second value in the header. In some embodiments, the second datagram may be a set of second datagrams of a message being communicated between the two link partners, and the other link partner may include the one of the first value and the second value in the header of each second datagram based on the immediately prior first datagram received from the link partner including the one of the first value or the second value in the header.

At 906, the method 900 may include sending, at a third time instance, a third datagram comprising a second value in the header to the other link partner over the at least one interconnect link. The link partner may in some examples toggle the header field of the third datagram to the other of the first value or the second value based on the immediately prior second datagram received from the other link partner including the first value or the second value in the header, which is the same value as was in the header of the first datagram received from link partner. The third datagram may be the same type of datagram as the first datagram. In some embodiments, the set of first datagrams of the message being communicated between the two link partners may include the first datagram and the third datagram.

The second time instance may be after the first time instance, and the third time instance may be after the first time instance and the second time instance. In addition, the first loop latency may be determined based on a difference between the third time instance and the first time instance. Each time instance may be a point in time, which may also be referred to as a time instant. The first loop latency may, in some examples, be the time between the first time instance and the third time instance that a given link partner sends the first datagram having the first value (e.g., first handshake code) and the third datagram having the second value (e.g., second handshake code), respectively. This difference may correspond to one measurement of the first loop latency, the first loop latency including one or more of these measurements. These measurements may in some examples be fed into a low-pass filter, and the resulting output from the low-pass filter may be representative of a measurement of an actual unloaded loop latency at the respective link partner. In some embodiments, a similar first loop latency may be measured for the other link partner in a similar manner as described with regard to the given link partner.

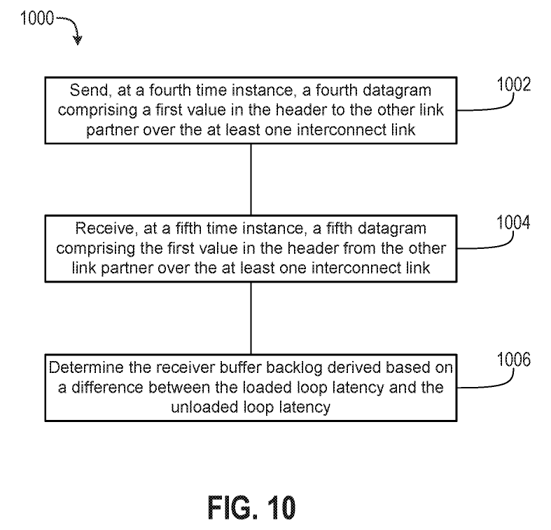

FIG. 10 is a flow diagram of an example method 1000 for measuring the first loop latency for data transmissions of datagrams between the two link partners over the at least one interconnect link, according to some embodiments. The method 1000 may be implemented in accordance with some techniques described herein, although other methods are possible. Method 1000 may be implemented with any combination of components and/or subsystems of system 100, system 200, system 300, computer system 400, system 500, system 600, and/or datagram 700. Method 1000 may be an embodiment of 804 of method 800. Method 1000 may be an embodiment of method 900.

At 1002, the method 1000 may include sending, at a fourth time instance, a fourth datagram comprising a first value in the header to the other link partner over the at least one interconnect link. In some embodiments, the fourth datagram may include one of the first value or the second value in the header. In some embodiments, the fourth datagram may be a set of datagrams of a message being communicated between the two link partners, and the link partner may toggle between the first value and the second value in the header of each datagram. The link partner may in some examples toggle the header field of each diagram being sent to the other link partner between the first value or the second value based on an immediately prior datagram received from the other link partner including the other of the first value or the second value in the header. In some embodiments, the datagrams may be for a read, write, or atomic messages being communicated between the two link partners.

At 1004, the method 1000 may include receiving, at a fifth time instance, a fifth datagram comprising the first value in the header from the other link partner over the at least one interconnect link. In some embodiments, the fifth datagram may include the one of the first value or the second value in the header. In some embodiments, the fifth datagram sent by the other link partner may be an acknowledgement datagram sent in response to an immediately prior fourth datagram received from the link partner including one of the first value or the second value in its header. In some embodiments, the fifth datagram may be one a set of datagrams of a message being communicated between the two link partners, and the other link partner may include the one of the first value and the second value in the header of each datagram sent to the link partner based on the one of the first value or the second value included in the header of the immediately prior datagram received from the link partner. Timing of the fifth datagram includes the current backlog latency through the link partner receive buffer.

At 1006, the method 1000 may include determining a receiver buffer backlog derived based on a difference between the second loop latency and the first loop latency. When the other link partner accepts the fourth datagram, the other link partner may send the fifth datagram to a receiver of the link partner as an acknowledgement. The acknowledgment may in some examples be sent by the other link partner when the fifth datagram was popped from its receiver buffer.

The second loop latency may in some examples include a difference between the fifth time instance and the fourth time instance. The second loop latency may be inclusive of a sixth time instance representative of when the other link partner sent the fifth datagram to a receiver of the link partner as acknowledgment of the fourth datagram. In some embodiments, the second loop latency measurement comprises a difference (e.g., time span) between the fifth time instance and the fourth time instance. The second loop latency may in some examples be a loaded loop latency measuring a time from when the link partner sends the fourth datagram having the first value to the time the link partner receives the fifth datagram having the same first value, the fifth datagram being an acknowledgment sent by the other link partner for the fourth datagram at a sixth time instance after the fourth time instance.

In some examples, the unloaded loop latency is representative of an ideal time without any backlog at the receiver buffer of the other link partner based on the time that it takes for the first datagram and the second datagram to pass over the respective links determined from the toggling of the handshake codes in the header by the transmitter of the link partner. Additionally, the loaded loop latency is representative of the time that it takes for the fourth datagram and the fifth datagram to pass over the respective links and is inherently representative of a latency at the receiver buffer backlog. Accordingly, the latency at the receiver buffer representative of the receiver buffer backlog can be inferred based on the difference between the loaded and unloaded loop latencies since the other link partner is configured to generate the fifth datagram as an acknowledgment to the fourth datagram at a sixth time instance when the other link partner pops the datagram from the receiver buffer.

Techniques operating according to the principles described herein can be implemented in any suitable manner. While the foregoing disclosure sets forth some examples using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts in accordance with the present disclosure. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory, accelerator memory, and/or system memory of the computer system 400 of FIG. 4 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within + 20%, + 10%, or + 5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. An apparatus comprising:
at least one circuit coupled between a data fabric of a host device and an interconnect link of an interconnect fabric, the at least one circuit comprising:
a receiver configured to receive datagrams from a link partner over the interconnect fabric;
a transmitter configured to send datagrams to the link partner over the interconnect fabric, and
wherein the transmitter is configured to monitor a loop latency for datagrams communicated with the link partner over the interconnect fabric using toggling handshake codes in a header of the datagrams, and
wherein, based on the monitored loop latency for the datagrams, the transmitter is configured to reduce a receiver buffer backlog at the link partner.

2. The apparatus of claim 1, wherein the transmitter is configured to convert a data stream from electrical signals received from the data fabric into datagrams for transmission to the link partner over the interconnect fabric.

3. The apparatus of claim 1, wherein the receiver is configured to convert the datagrams received from the link partner over the interconnect fabric into electrical signals to send to a storage media of the host device over the data fabric.

4. The apparatus of claim 1, wherein monitoring the loop latency comprises:
monitoring, by the transmitter, an unloaded loop latency for the datagrams;
monitoring, by the transmitter, a loaded loop latency for the datagrams; and
comparing, by the transmitter, a difference between the unloaded loop latency and the loaded loop latency to one or more thresholds,
wherein the transmitter is configured to reduce the receiver buffer backlog at the link partner in response to the difference between the unloaded loop latency and the loaded loop latency exceeding the one or more thresholds.

5. The apparatus of claim 4, wherein monitoring the unloaded loop latency for the datagrams comprises:
sending, at a first time instance, a first datagram comprising a first handshake code in the header to the link partner over the interconnect fabric;
receiving, at a second time instance, a second datagram comprising the first handshake code in the header from the link partner over the interconnect fabric; and
sending, at a third time instance, a third datagram comprising a second handshake code in the header to the link partner over the interconnect fabric,
wherein the second time instance is after the first time instance, and the third time instance is after the first time instance and the second time instance, and wherein the unloaded loop latency comprises a difference between the third time instance and the first time instance.

6. The apparatus of claim 5, wherein monitoring the loaded loop latency for the datagrams comprises:
sending, at a fourth time instance, a fourth datagram comprising a first handshake code in the header to the link partner over the interconnect fabric;
receiving, at a fifth time instance, a fifth datagram comprising the first handshake code in the header from the link partner over the interconnect fabric, wherein the loaded loop latency comprises a difference between the fifth time instance and the fourth time instance; and
determining the receiver buffer backlog derived based on a difference between the loaded loop latency and the unloaded loop latency;
wherein the fifth time instance is after the fourth time instance, and wherein the fifth time instance includes a latency from the receiver buffer backlog from being generated at a sixth time instance when the link partner acknowledged the fourth datagram.

7. The apparatus of claim 4, wherein reducing the receiver buffer backlog at the link partner comprises:
generating at least one sixth datagram based on the comparison of the difference between the unloaded loop latency and the loaded loop latency to the one or more thresholds; and
sending the at least one sixth datagram to the link partner,
wherein each sixth datagram is configured to reduce the receiver buffer backlog at the link partner.

8. The apparatus of claim 7, wherein the transmitter does not package a data payload into each sixth datagram.

9. The apparatus of claim 7, wherein each sixth datagram is configured not to be consumed by the link partner.

10. A system comprising:
a plurality of nodes, each node connected to an interconnect fabric for transmission of datagrams between link partners, each node comprising:
at least one processor coupled to a data fabric;
at least one storage media coupled to the data fabric; and
at least one circuit coupled between the data fabric and an interconnect link of the interconnect fabric for transmission of data between the data fabric and the interconnect link, the at least one circuit comprising:
a receiver configured to convert datagrams received from a link partner over the interconnect fabric into electrical signals to send to a storage media over the data fabric, and
a transmitter configured to convert a data stream from electrical signals received from the data fabric into datagrams for transmission to the link partner over the interconnect fabric,
wherein the transmitter is further configured to monitor a loop latency for datagrams communicated with the link partner over the interconnect fabric using toggling handshake codes in a header of the datagrams, and
wherein, based on the monitored loop latency for the datagrams, the transmitter is configured to reduce a receiver buffer backlog at the link partner.

11. The system of claim 10, wherein monitoring the loop latency comprises:
monitoring, by the transmitter, a first loop latency for the datagrams;
monitoring, by the transmitter, a second loop latency for the datagrams; and
comparing, by the transmitter, a difference between the first loop latency and the second loop latency to one or more thresholds,
wherein the transmitter is configured to reduce the receiver buffer backlog at the link partner in response to the difference between the first loop latency and the second loop latency exceeding the one or more thresholds.

12. The system of claim 11, wherein monitoring the first loop latency for the datagrams comprises:
sending a first datagram comprising one of a first or second handshake code in the header to the link partner over the interconnect fabric;
receiving a second datagram comprising the one of the first or second handshake code in the header from the link partner over the interconnect fabric;
sending a third datagram comprising the other of the first or second handshake code in the header to the link partner over the interconnect fabric; and
determining the first loop latency based on a time span between the sending of the first datagram and the sending of the third datagram.

13. The system of claim 12, wherein monitoring the second loop latency for the datagrams comprises:
sending a fourth datagram comprising a first sequence number in the header to the link partner over the interconnect fabric;
receiving a fifth datagram comprising the first sequence number in the header from the link partner over the interconnect fabric;
determining the second loop latency based on a time span between a time the transmitter sent the fourth datagram and a time the receiver received the fifth datagram;
determining the receiver buffer backlog derived based on a difference between the second loop latency and the first loop latency.

14. The system of claim 11, wherein reducing the receiver buffer backlog at the link partner comprises:
generating at least one sixth datagram based on the comparison of the difference between the first loop latency and the second loop latency to the one or more thresholds; and
sending the at least one sixth datagram to the receiver buffer of the link partner,
wherein each sixth datagram is configured to reduce the receiver buffer backlog at the link partner.

15. The system of claim 14, wherein the transmitter does not package a data payload into the at least one sixth datagram.

16. The system of claim 14, wherein the receiver buffer of the link partner does not consume the at least one sixth datagram.

17. A method comprising:
measuring a first loop latency for data transmissions of datagrams between two link partners over at least one interconnect link, a header of the datagrams including one of a first value and a second value;
measuring a second loop latency for data transmission of datagrams between the two link partners over the at least one interconnect link;
calculating, by a link partner, a value characterizing a degree of a backlog in a receiver buffer of the other link partner based on the measured first loop latency and the measured second loop latency; and
responsive to the calculated value exceeding at least one threshold, transmitting, by the link partner, at least one non-operative (NOP) datagram to the other link partner over the at least one interconnect link, the at least one NOP datagram configured to reduce the backlog in the receiver buffer of the other link partner.

18. The method of claim 17, wherein monitoring the first loop latency for the datagrams comprises:
sending, at a first time instance, a first datagram comprising a first handshake code in the header to the other link partner over the at least one interconnect link;
receiving, at a second time instance, a second datagram comprising the first handshake code in the header from the other link partner over the at least one interconnect link; and
sending, at a third time instance, a third datagram comprising a second handshake code in the header to the other link partner over the at least one interconnect link,
wherein the second time instance is after the first time instance, and the third time instance is after the first time instance and the second time instance, and wherein the first loop latency is determined based on a difference between the third time instance and the first time instance.

19. The method of claim 18, wherein monitoring the second loop latency for the datagrams comprises:
sending, at a fourth time instance, a fourth datagram comprising a first handshake code in the header to the other link partner over the at least one interconnect link;
receiving, at a fifth time instance, a fifth datagram comprising the first handshake code in the header from the other link partner over the at least one interconnect link, the second loop latency comprising a difference between the fifth time instance and the fourth time instance; and
determining the receiver buffer backlog derived based on a difference between the second loop latency and the first loop latency;
wherein the fifth time instance is after the fourth time instance.

20. The method of claim 17, further comprising:
generating the NOP datagram based on a comparison of a difference between the first loop latency and the second loop latency to the at least one threshold; and
sending the NOP datagram to a receiver of the other link partner,
wherein the link partner does not package a data payload into the NOP datagram, and wherein the NOP datagram is configured to reduce the receiver buffer backlog at the other link partner.
